(19) United States
(12) Patent Application Publication
(10) Pub. No.: US 2024/0029004 A1
(43) Pub. Date: Jan. 25, 2024

(54) RUNTIME GUIDED OPTIMIZATION OF BUSINESS ASSET COMPONENTS

(71) Applicant: Red Hat, Inc., Raleigh, NC (US)

(72) Inventors: Edoardo Vacchi, Milan (IT); Paolo Antinori, Milan (IT)

(21) Appl. No.: 17/871,309

(22) Filed: Jul. 22, 2022

(51) Int. Cl. G06Q 10/06; G06F 9/455

(52) U.S. Cl. CPC G06Q 10/067; G06F 9/45516

(57) ABSTRACT

Trace data generated by a set of executing business asset components of a plurality of business asset components that form a business process application are received. Source code that defines the plurality of business asset components is received. Based on the trace data and the source code, native binary executable code is generated for a first subset of the business asset components and interpretable code for a second subset of business asset components is maintained.

### BACKGROUND

Business automation is a technological area of growing interest and importance that facilitates the implementation of a business application on a computing system via a standardized notation system.

### SUMMARY

The examples disclosed herein implement runtime guided optimization of business asset components. In particular, a plurality of business asset components that form a business process application execute, and while executing provide trace data about the business asset components.

Subsequently, source code that defines the plurality of business asset components is accessed, and based on the trace data and the source code, native binary executable code is generated for some of the business asset components, and others of the business asset components are maintained in an interpretable code format.

In one example a method is provided. The method includes receiving, by a computing system comprising one or more computing devices, trace data generated by a set of executing business asset components of a plurality of business asset components that form a business process application. The method further includes receiving, by the computing system, source code that defines the plurality of business asset components. The method further includes generating, based on the trace data and the source code, native binary executable code for a first subset of the business asset components and maintaining interpretable code for a second subset of business asset components.

In another example a computing system is provided. The computing system includes one or more computing devices, the one or more computing devices comprising one or more processor devices. The one or more processor devices are to receive trace data generated by a set of executing business asset components of a plurality of business asset components that form a business process application. The one or more processor devices are further to receive source code that defines the plurality of business asset components. The one or more processor devices are further to generate, based on the trace data and the source code, native binary executable code for a first subset of the business asset components and maintaining interpretable code for a second subset of business asset components.

In another example a non-transitory computer-readable storage medium is provided. The non-transitory computer-readable storage medium includes executable instructions to cause one or more processor devices of one or more computing devices to receive trace data generated by a set of executing business asset components of a plurality of business asset components that form a business process application. The instructions further cause the one or more processor devices to receive source code that defines the plurality of business asset components The instructions further cause the one or more processor devices to generate, based on the trace data and the source code, native binary executable code for a first subset of the business asset components and maintaining interpretable code for a second subset of business asset components.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIGS. 1A-1B are block diagrams illustrating an environment suitable for implementing runtime guided optimization of business asset components according to one example;

FIG. 2 is a flowchart of a method for implementing runtime guided optimization of business asset components according to one implementation;

FIG. 3 is block diagram illustrating a set of business asset components according to one implementation;

FIG. 4 is a block diagram illustrating runtime guided optimization of business asset components according to one implementation;

FIG. 5 is a block diagram illustrating an environment suitable for implementing runtime guided optimization of business asset components according to another example;

FIG. 6 is a simplified block diagram of the computing system illustrated in FIG. 1; and

FIG. 7 is a block diagram of a computer that is operable to execute processes and methods in accordance with various aspects of the subject disclosure.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but, unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context.

The term “business automation” as used herein refers to the use of predetermined modeling and notation systems that facilitate the modeling of business processes and/or decision services for visualization purposes, and also facilitate the implementation of such business processes and decision services through software instructions that, when interpreted, or compiled and executed, implement a desired business data processing system on one or more computing devices.

Business process modeling is the activity of representing a business process made up of, for example, one or more tasks, rules, decisions, predictive models, or conditions. The business process may be any desired business activity, such as the business process of receiving an order from a customer, filling the order, and shipping the order. Business process modeling facilitates the understanding of the business process via visualization of the underlying decisions, rules and the like, that make up the business process. Such decisions, rules and the like may be referred to herein as business asset components. Electronic notation systems exists that utilize a syntax to encode objects that define business asset components and relationships between such objects in a data file. Examples of such notation systems include, by way of non-limiting example, Business Process and Model Notation (BPMN), available at www.omg.org, Decision Model and Notation (DMN), available at www.omg.org, Predictive Model Markup Language (PMML), available at www.dmg.org, and Drools Rules Language (DRL), available at www.drools.org. Data files using a notation syntax to encode one or more business asset components may be referred to herein as a notation file.

Various business automation software applications can read such notation files and visualize the business asset components encoded in such notation files on a display device to allow a user to quickly and intuitively understand the business asset components that model a particular business process.

Business process automation (BPA) is the use of software to automate repeatable, multistep business transactions. Business process automation platforms, such as Kogito, available at kogito.kie.org, facilitate the concurrent generation and visualization of business asset components with the ability to generate actual software instructions (e.g., source code) that implement the business asset component on a computing device.

Different notation systems may be used to model different types of business asset components of a business process model. For example, a BPMN notation file (i.e., a file that utilizes the BPMN syntax to encode business asset components) may be used to model certain types of business asset components, such as tasks, and a DMN notation file (i.e., a file that utilizes the DMN syntax to encode business asset components) may be used to model other types of business asset components, such as decisions.

Notation files may contain references to other notation files. For example, a BPMN notation file may contain a reference to a DMN notation file. As discussed above, a business process automation platform, such as Kogito, may be used to generate software instructions that implement one or more business asset components of a business process model. Collectively, the software instructions that implement a business process model may be referred to herein as a business process application. The software instructions may be pre-processed prior to running the business process application to make the execution of the business process application more efficient. For example, the software instructions of the business asset components may be compiled to form one or more binary executables.

A large business process application may include hundreds or thousands of different business asset components, resulting in thousands of different potential paths (sometimes referred to as code paths) through the business process application from the start of a transaction to the end of the transaction. The particular path taken by any particular transaction may vary depending on different input variables and other criteria. In practice, out of thousands of potential paths, on a small subset of paths may actually be used for the vast majority of transactions. Compiling thousands of business asset components can take a substantial amount of time, and may result in a large executable binary that requires substantial computing resources, such as memory resources, storage resources, and the like.

Some business process automation platforms, such as Kogito, can execute a business asset component that is in either of two forms: 1) native binary code (sometime referred to as optimized) or 2) interpretable code. A business asset component in native binary code will execute more efficiently because the processor device of the computing device on which the business asset component executes can directly execute the native binary code (e.g., no translation or interpretation is necessary). However, generating the native binary code takes times, and increases the size of the binary executable. To reduce the size of the binary executable of a business process application it would be desirable to pre-process only those business asset components that are more likely to be executed in a typical transaction, while keeping other business asset components that are less frequently used in a non-binary interpretable form.

The examples disclosed herein implement runtime guided optimization of business asset components. In particular, a plurality of business asset components that form a business process application execute, and while executing provide trace data about the business asset components. Subsequently, source code that defines the plurality of business asset components is accessed, and based on the trace data and the source code, native binary executable code is generated for some of the business asset components, and others of the business asset components are maintained in an interpretable code format.

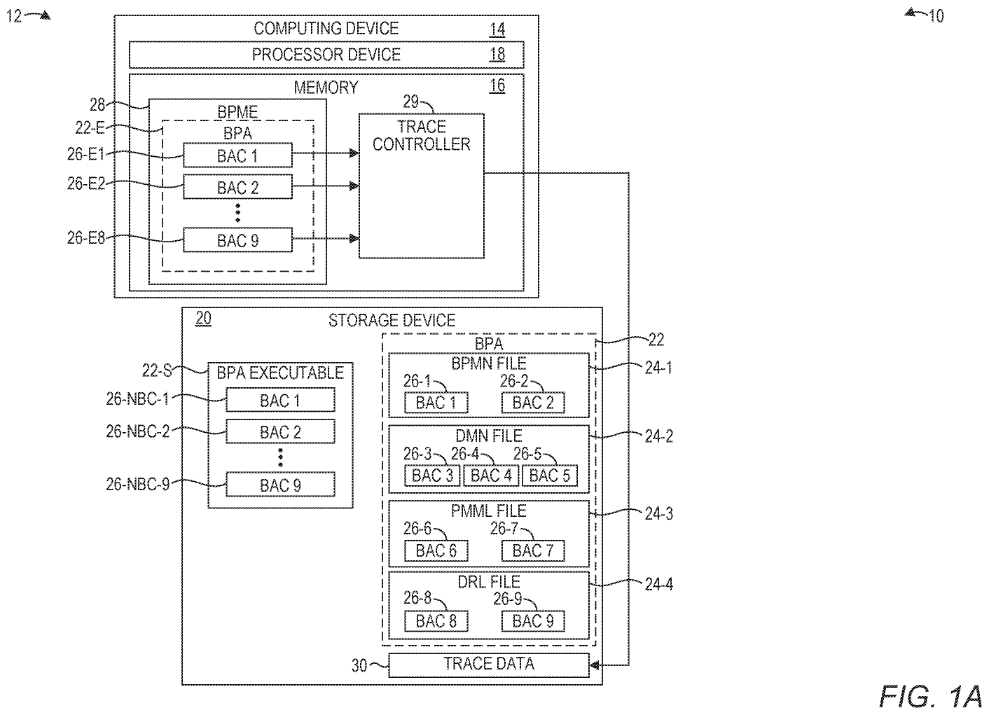

FIGS. 1A-1B are block diagrams illustrating an environment 10 suitable for implementing runtime guided optimization of business asset components according to one example. Referring first to FIG. 1A, the environment 10 includes a computing system 12 that includes a computing device 14. The computing device 14 includes a memory 16 and a processor device 18 coupled to the memory 16. In some implementations the environment may comprise a cloud computing environment.

The environment 10 includes one or more storage devices 20 on which is stored a business process application (BPA) 22. The BPA 22 is composed of a plurality of business process model notation files 24-1-24-4 (generally, notation files 24) that collectively describe a business application, such as an inventory system, an online ordering system, an accounting system, or the like. As discussed above, the term “notation file” as used herein refers to files that utilize a notation syntax to encode/define one or more business asset components, as well as relationships between such business asset components. By way of non-limiting example, notation files include files utilizing a BPMN syntax, a DMN syntax, a PMML syntax, or a DRL syntax. The term business asset component refers to a discrete component encoded in a notation file. The discrete component may differ depending on the particular notation syntax used. For example, a component in a BPMN notation file may comprise a task business asset component that implements a desired processing algorithm, a component in a DMN notation file may comprise a decision business asset component that returns, based on one or more criterion, a decision output, a component in a PMML notation file may comprise a predictive model business asset component, a component in a Drool notation file may comprise a rule business asset component. Visualization applications can read a notation file and present on a display device symbols that correspond to the individual business asset components defined therein and also provide information, such as lines and/or arrows to indicate relationships between business asset components defined in a notation file.

In this example, the notation file 24-1 comprises a BPMN notation file and defines two task business asset components 26-1 and 26-2. The notation file 24-2 comprises a DMN notation file and defines three decision business asset components 26-3, 26-4, and 26-5. The notation file 24-3 comprises a PMML notation file and defines two predictive model business asset components 26-6 and 26-7. The notation file 24-4 comprises a DRL notation file and defines two rule business asset component 26-8 and 26-9. The business asset components 26-1-26-9 may be referred to herein generally as business asset components 26. While for purposes of illustration the business process application 22 includes nine business asset components 26, in practice, a business process application may comprise hundreds or thousands of business asset components.

The notation files 24 include information suitable for visualizing on a display device the business asset components 26. Via the use of a business process automation platform, such as Kogito, the business asset components 26 may also include source code instructions that, when executed, implement the corresponding business asset component 26 on a computing device, such as the computing device 14. The source code instructions may be incorporated in the notation files 24 or may be maintained in associated files. For purposes of illustration and simplicity each business asset component 26 will be described herein as including the software instructions that implement the respective business asset component 26, but it is apparent that the software instructions in practice be maintained in associated files.

The business asset components 26 may each be processed, such as compiled, to generate a business process application 22-S. The business process application 22-S, in this example, comprises a plurality of native binary code business asset components 26-NBC-1-26-NBC-9 (generally, business asset components 26-NBC), which correspond, respectively, to the business asset components 26-1-26-9. For example, the business asset component 26-NBC-1 is a compiled version of the business asset component 26-1.

Each of the business asset components 26-NBC is capable, when executing, of providing trace data to a predetermined location. The trace data comprises information generated at runtime about the respective business asset component 26. The trace data may include input values, output values, memory utilization, processor utilization, or any other information about the business asset component 26-NBC. The business asset component 26-NBC may provide the trace data only when the business asset component 26-NBC executes, so the receipt of trace data from a business asset component 26-NBC may be an indication that the business asset component 26-NBC has been invoked for a particular transaction. In some implementations the trace data may be generated via a tracing platform such as Jaeger, available at www.jaegertracing.io, or Prometheus, available at prometheus.io.

In this example, the BPA 22-S has been initiated on the computing device 14 as an executing BPA 22-E. The executing BPA 22-E runs in, or in conjunction with, one or more business process model engines (BPME) 28, such as jBPM (jPBM.org) or Drools (drools.org). Each of the business asset components 26-NBC-1-26-NBC-9 execute in the memory 16 as corresponding executing business asset components 26-E1-26-E9 (generally, executing business asset components 26-E). For example, the business asset component 26-E1 is initiated from the business asset component 26-NBC-1, and when executing implements the business asset component 26-1. In some implementations the business asset components 26-E may comprise containers that are executing in conjunction with a container orchestration system, such as Kubernetes (kubernetes.io). The BPME 28 may include an interpreter, or may operate in conjunction with an interpreter. In some implementations, the interpreter may comprise a Java virtual machine.

During execution, the business asset components 26-E each provide trace data to a trace controller 29. The trace controller 29 may store the trace data as trace data 30 on a suitable storage device, such as the storage device 20. The business asset components 26-E may execute for a sufficient period of time in a production environment to provide accurate trace data that provides information about the execution of the business asset components 26-E. The trace data 30 may identify, for example, information that identifies the number of times a business asset component 26-E was invoked, the values of input variables or input constants to each respective business asset component 26-E, the invoking business asset component 26-E, output values provided to an immediate downstream business asset component 26-E, which other business asset components 26-E were invoked by a business asset component 26-E, values returned by any business asset components 26-E invoked by the business asset component 26-E, and/or computing resource usage information of the business asset component 26-E.

Referring now to FIG. 1B, the environment 10 may include a business process application builder 32 that operates to generate a business process application 22-N based on the source code that implements the business asset components 26 and the trace data 30. While for purposes of illustration the business process application builder 32 is illustrated as executing on the computing device 14, in practice the business process application builder 32 need not execute on the same computing device as that of the executing business asset components 26-E.

The business process application builder 32 accesses or otherwise receives the source code that implements the business asset components 26 and the trace data 30. Based on the trace data 30 and the source code, the business process application builder 32 generates native binary executable code for a first subset of the business asset components 26 and maintains interpretable code for a second subset of business asset components 26. The term “interpretable code” means instructions that are not native binary code and cannot directly be executed by the processor device 18. The term “maintains” refers to not translating the source code of the respective business asset components 26 at all, or to translating the source code of the respective business asset components 26 to an intermediate form of instructions that is interpretable, but is not directly executable by the processor device 18.

In this example, the business process application builder 32 generates native binary code for a first subset of business asset components that includes business asset components 26-NBC-1, 26-NBC-2, 26-NBC-4, 26-NBC-6, and 26-NBC-8. The business process application builder 32 maintains business asset components 26-INT-2, 26-INT-3, 26-INT-5, 26-INT-7, and 26-INT-9 as interpretable code.

The business process application builder 32 may determine which business asset components 26 should be optimized (i.e., should have native binary code generated) and which business asset components 26 should not be optimized based on one more criteria. As an example, the business process application builder 32 may, based on the trace data 30, sum the number of times each business asset component 26 executed. The business process application builder 32 may compare the total number N times a business asset component 26 executed to a determined threshold 34. If the total number N is greater than the determined threshold 34, the business process application builder 32 generates native binary code for the respective business asset component 26. If the total number N is less than the determined threshold 34, the business process application builder 32 maintains interpretable code for the respective business asset component 26. In other examples the threshold may be a percentage of times, for a set of transactions, that a particular business asset component 26 is executed. For example, for business asset components 26 that are invoked in 50% or more of the transactions, native binary code is generated, and for business asset components 26 that are invoked for less than 50% of the transactions, interpretable instructions are maintained.

In some implementations, the business process application builder 32 may identify different code paths, or transaction paths, through the business asset components 26 based on the trace data 30 that are dependent on the values of input variables to the respective business asset components 26. The business process application builder 32 may then analyze the source code that implements the business asset components 26 to determine a value of an input variable to a first business asset component 26, access the trace data 30 associated with the first business asset component 26, and based on the value of the input variable and the trace data 30, generating native binary executable code for the first business asset component 26.

Similarly, for a second business asset component 26, the business process application builder 32 may analyze the source code that implements the second business asset component 26 to determine a value of an input variable to the second business asset component 26, access the trace data 30 associated with the second business asset component 26, and based on the value of the input variable and the trace data 30, maintain interpretable code for the second business asset component 26.

It is noted that, because the business process application builder 32 is a component of the computing device 14, functionality implemented by the business process application builder 32 may be attributed to the computing device 14 generally. Moreover, in examples where the business process application builder 32 comprises software instructions that program the processor device 18 to carry out functionality discussed herein, functionality implemented by the business process application builder 32 may be attributed herein to the processor device 18.

It is further noted that while, for purposes of illustration and simplicity, the examples are illustrated as being implemented by a computing system that comprises a single computing device that, in turn, comprises a single processor device, in practice the examples disclosed herein may be implemented in a computing system that comprises any number of computing devices, each of which may comprise one or more processor devices. Thus, irrespective of the implementation, the examples may be implemented on a computing system that includes one or more computing devices, wherein the one or more computing devices comprise one or more processor devices, and wherein the one or more processor devices are configured to implement functionality disclosed herein.

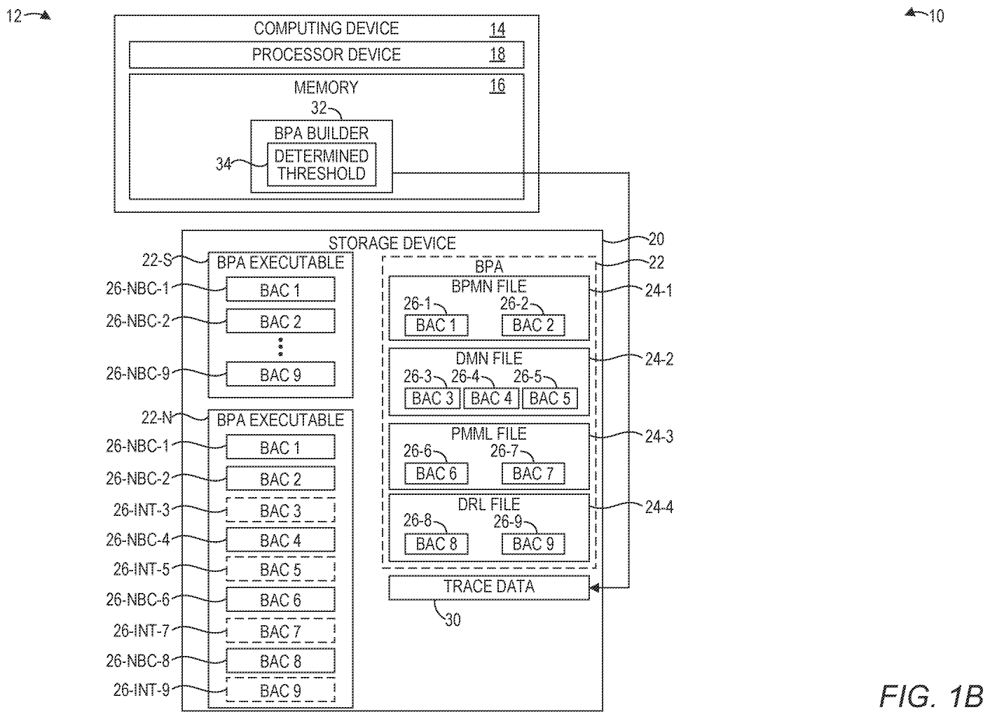

FIG. 2 is a flowchart of a method for implementing runtime guided optimization of business asset components according to one implementation. FIG. 2 will be discussed in conjunction with FIG. 1B. The computing system 12 receives the trace data 30 generated by the set of executing business asset components of the plurality of business asset components 26-E that form the BPA 22-E (FIG. 2, block 1000). The computing system 12 receives the source code that defines the plurality of business asset components 26 (FIG. 2, block 1002). The computing system 12 generates, based on the trace data 30 and the source code, native binary executable code for the first subset of business asset components 26-1, 26-2, 26-4, and 26-8, and maintains interpretable code for the second subset of business asset components 26-3, 26-5, 26-7 and 26-9 (FIG. 2, block 1004).

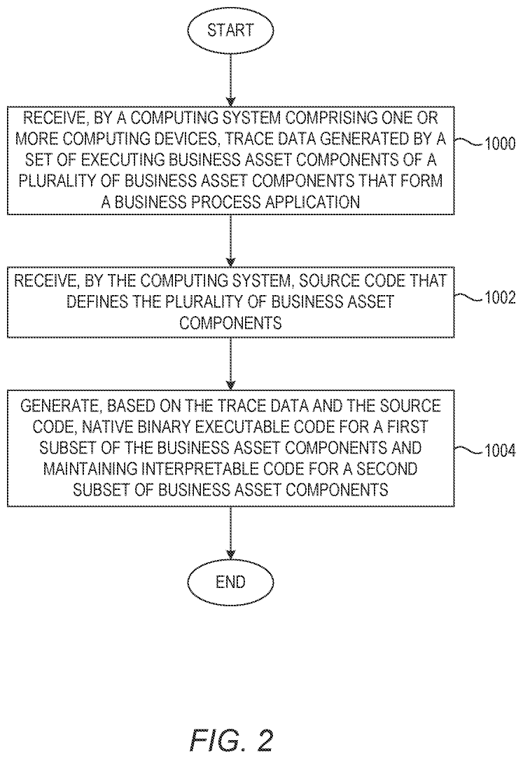

FIG. 3 is block diagram illustrating relationships between the business asset components 26-1, 26-2 defined in the notation file 24-1 and the business asset components 26-3-26-5 defined in the notation file 24-2. The business asset components 26-2 and 26-2 are BPMN task business asset components that implement desired processing of an input transaction. The business asset component 26-2 invokes one of the DMN decision business asset components 26-1-26-3 based on some criteria, which may depend, at least on part, on characteristics of the input transaction. Thus, the notation file 24-1 contains a reference to the notation file 24-2. After receiving the decision from the particular business asset component 26-3-26-5 that is invoked, the business asset component 26-2 transfers control to a downstream business asset component 26-X (which may differ depending on the particular decision).

Assume for purposes of illustration that after the BPA 22-E executes for a period of time, the trace data 30 indicates that the executing business asset components that correspond to the business asset components 26-1 and 26-2 are invoked for 95% of all transactions, the executing business asset component that corresponds to the business asset component 26-4 is invoked for 70% of all transactions, and the executing business asset components that correspond to the business asset components 26-3 and 26-5 are each invoked for 15% of all transactions.

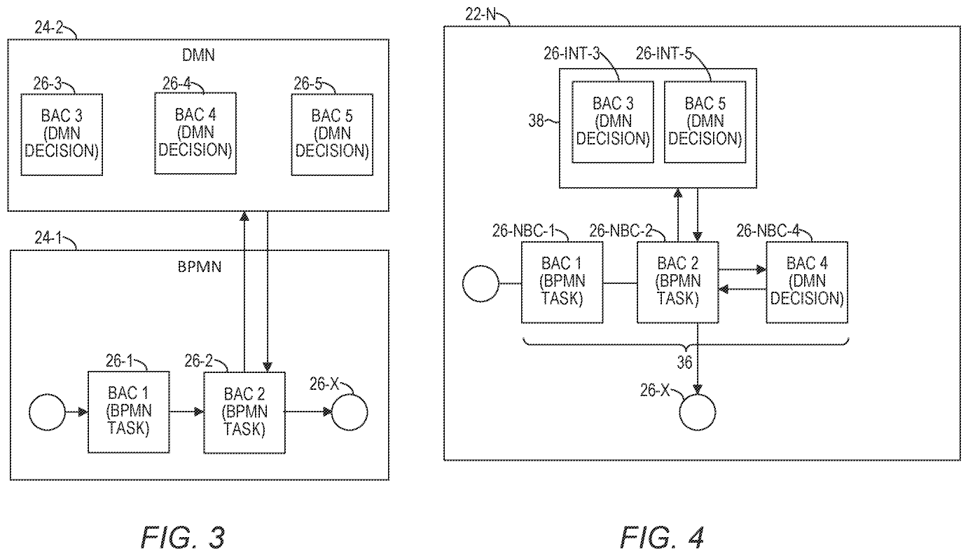

Referring now to FIG. 4, a block diagram illustrating a portion of the business process application 22-N is depicted. For purposes of illustration assume that the BPA builder 32 uses a determined threshold of 50% invocation rate to determine whether to generate native binary code for a business asset component 26. Based on the trace data 30 generated as described above with reference to FIG. 3, the BPA builder 32 generates native binary code for the set 36 of business asset components 26-1, 26-2 and 26-4. Based on the trace data 30 generated as described above with reference to FIG. 3A, the BPA builder 32 maintains interpretable code for the set 38 of business asset components 26-3 and 26-4. Thus, during execution, if the executing business asset component that corresponds to the business asset component 26-4 is invoked, the executing business asset component runs natively on the processor device 18. If the executing business asset component that corresponds to the business asset component 26-3 is invoked on the other hand, the executing business asset component in interpreted by an interpreter (e.g., a Java virtual machine) executing on the processor device 18.

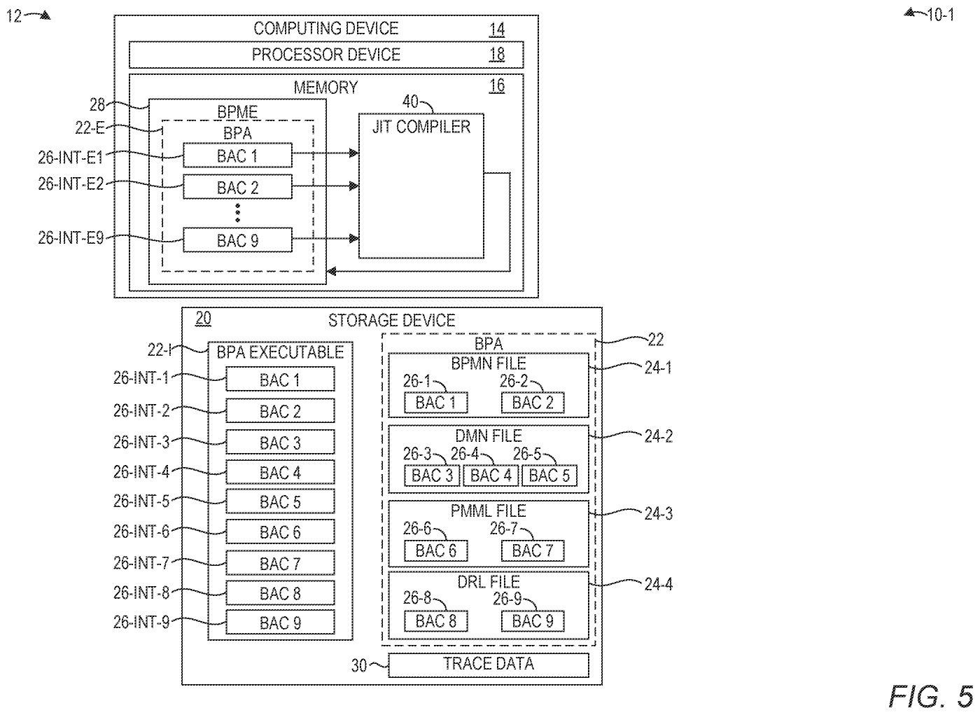

FIG. 5 is a block diagram illustrating an environment 10-1 suitable for implementing runtime guided optimization of business asset components according to another example. FIG. 10-1 is substantially similar to the environment 10 illustrated in FIG. 1 except as otherwise discussed herein. In this example, a business process executable 22-I contains only interpretable code. The business process executable 22-I is initiated as an executing BPA 22-E. The BPA 22-E includes a plurality of executing business asset components 26-INT-E1-26-INT-E9, each of which corresponds respectively to a business asset 26-1-26-9. Each of the executing business asset components 26-INT-E1-26-INT-E9 are initially maintained as interpretable code and, when invoked during a transaction, are interpreted. While the executing business asset components 26-INT-E1-26-INT-E9 are executing, the executing business asset components 26-INT-E1-26-INT-E9 provide trace data to a just-in-time (JIT) compiler 40 that is configured to generate native binary code in real-time, and cause the native binary code to be executed by the processor device 18.

The JIT compiler 40 receives the trace data from the executing business asset components 26-INT-E1-26-INT-E9 concurrently with the execution of the executing business asset components 26-INT-E1-26-INT-E9 and may determine, based on real-time trace data, that a particular business asset component 26-INT-E1-26-INT-E9 is invoked a sufficient number of times, a sufficient percentage of the time, or meets some other criteria, that the particular business asset component 26-INT-E1-26-INT-E9 should be compiled into native binary code rather than maintained in interpretable code. The JIT compiler 40 then compiles the particular business asset component 26-INT-E1-26-INT-E9 into native binary code and when invoked, causes the processor device 18 to execute the native binary code in lieu of being interpreted by the interpreter. The JIT compiler 40 may replace the interpretable executing business asset component 26-INT-E1-26-INT-E9 with the native binary code so that subsequent invocations of the executing business asset component 26-INT-E1-26-INT-E9 are executed by the processor device 18 in lieu of being interpreted by the interpreter.

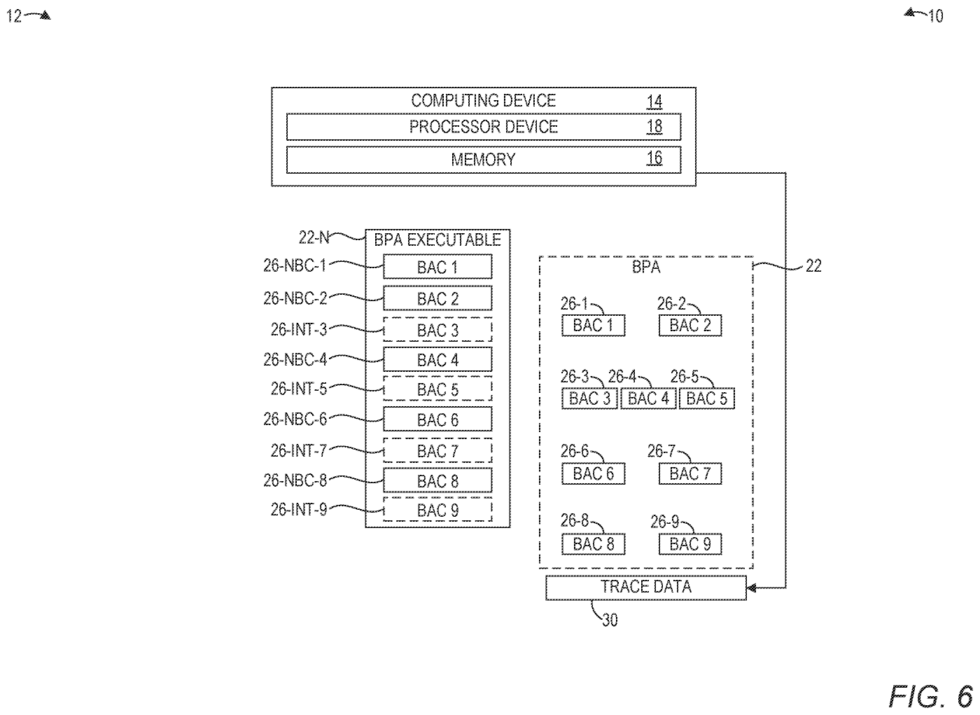

FIG. 6 is a simplified block diagram of the environment 10 illustrated in FIG. 1 according to another implementation. The environment 10 includes the computing system 12 which includes one or more computing devices 14. The one or more computing devices 14 each include one or more processor devices 18. The one or more processor devices 18 are to receive the trace data 30 generated by the set of executing business asset components 26-E of the plurality of business asset components 26 that form the business process application 22. The one or more processor devices 18 are further to receive source code that defines the plurality of business asset components 26, and generate, based on the trace data 30 and the source code, the native binary executable code for the first subset of the business asset components 26-NBC-1, 26-NBC-2, 26-NBC-4, 26-NBC-6, and 26-NBC-8, and maintain interpretable code for the second subset of business asset components 26-INT-1, 26-INT-3, 26-INT-26-INT-7, and 26-INT-9.

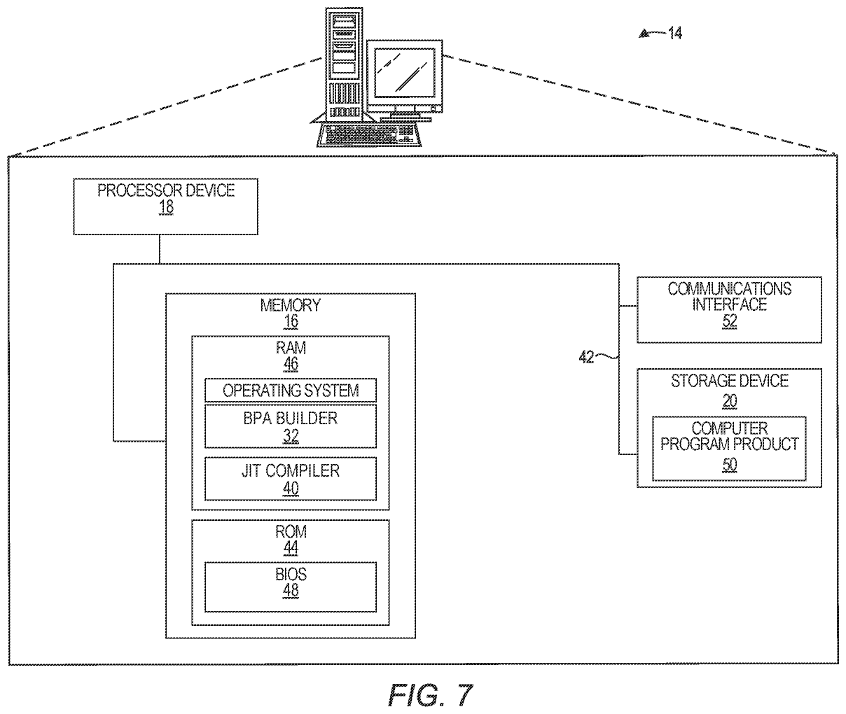

FIG. 7 is a block diagram of the computing device 14 according to one example. The computing device 14 may comprise any computing or electronic device capable of including firmware, hardware, and/or executing software instructions to implement the functionality described herein, such as a computer server, a desktop computing device, a laptop computing device, or the like. The computing device 14 includes the processor device 18, the memory 16, and a system bus 42. The system bus 42 provides an interface for system components including, but not limited to, the memory 16 and the processor device 18. The processor device 18 can be any commercially available or proprietary processor device.

The system bus 42 may be any of several types of bus structures that may further interconnect to a memory bus (with or without a memory controller), a peripheral bus, and/or a local bus using any of a variety of commercially available bus architectures. The memory 16 may include a non-volatile memory 44 (e.g., read-only memory (ROM), erasable programmable read-only memory (EPROM), electrically erasable programmable read-only memory (EEPROM, etc.), and a volatile memory 46 (e.g., random-access memory (RAM)). A basic input/output system (BIOS) 48 may be stored in the non-volatile memory 44 and can include the basic routines that help to transfer information between elements within the computing device 14. The volatile memory 46 may also include a high-speed RAM, such as static RAM, for caching data.

The computing device 14 may further include or be coupled to a non-transitory computer-readable storage medium such as the storage device 20, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 20 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as Zip disks, magnetic cassettes, flash memory cards, cartridges, and the like, may also be used in the operating environment, and, further, that any such media may contain computer-executable instructions for performing novel methods of the disclosed examples.

A number of modules can be stored in the storage device 20 and in the volatile memory 46, including an operating system and one or more components, such as the BPA builder 32 and/or the JIT compiler 40. Such components may implement the functionality described herein in whole or in part. It is to be appreciated that the examples can be implemented with various commercially available operating systems or combinations of operating systems.

All or a portion of the examples may be implemented as a computer program product 50 stored on a transitory or non-transitory computer-usable or computer-readable storage medium, such as the storage device 20, which includes complex programming instructions, such as complex computer-readable program code, to cause the processor device 18 to carry out the steps described herein. Thus, the computer-readable program code can comprise software instructions for implementing the functionality of the examples described herein when executed on the processor device 18. The computing device 14 may also include a communications interface 52 suitable for communicating with a mobile wireless network or other computing devices as appropriate or desired.

Those skilled in the art will recognize improvements and modifications to the preferred examples of the disclosure. All such improvements and modifications are considered within the scope of the concepts disclosed herein and the claims that follow.

What is claimed is:

1. A method comprising:
receiving, by a computing system comprising one or more computing devices, trace data generated by a set of executing business asset components of a plurality of business asset components that form a business process application;
receiving, by the computing system, source code that defines the plurality of business asset components; and
generating, based on the trace data and the source code, native binary executable code for a first subset of the business asset components and maintaining interpretable code for a second subset of the business asset components.

2. The method of claim 1 further comprising:
determining, by the computing system based on the trace data, that each business asset component in the first subset of business asset components executed a total number N times;
determining, by the computing system, that the number N is greater than a determined threshold; and
in response to determining that the number N is greater than the determined threshold, generating the native binary executable code for each business asset component in the first subset of business asset components.

3. The method of claim 1 further comprising:
determining, by the computing system based on the trace data, that each business asset component in the second subset of business asset components executed a total number M times;
determining, by the computing system, that the number M is less than a determined threshold; and
in response to determining that the number M is less than the determined threshold, maintaining the interpretable code for each business asset component in the second subset of business asset components.

4. The method of claim 1 wherein the plurality of business asset components comprise one or more of a Business Process Model and Notation (BPMN) task business asset component, a Drool rule business asset component, and a Decision Model and Notation decision business asset component.

5. The method of claim 1 wherein the trace data includes data identifying values of input variables used by the set of executing business asset components, and wherein generating, based on the trace data and the source code, the native binary executable code for the first subset of the business asset components further comprises:
analyzing the source code to determine a value of an input variable to a first business asset component of the first subset of the business asset components;
accessing the trace data associated with the first business asset component; and
based on the value of the input variable and the trace data, generating native binary executable code for the first business asset component.

6. The method of claim 1 wherein the trace data includes data identifying values of input variables used by the set of executing business asset components, and wherein maintaining, based on the trace data and the source code, the interpretable code for each of the business asset components in the second subset of component further comprises:
analyzing the source code to determine a value of an input variable to a first business asset component;
accessing the trace data associated with the first business asset component; and
based on the value of the input variable and the trace data, maintaining the interpretable code for the first business asset component.

7. The method of claim 1, wherein the source code comprises one or more of a Decision Modeling and Notation (DMN) syntax, a Business Process Model Notation (BPMN) syntax, a Predictive Model Markup Language (PMML) syntax, and a Drools Rule Language (DRL) syntax.

8. The method of claim 1, wherein receiving, by the computing system, the trace data generated by the set of executing business asset components further comprises receiving, by a just in time (JIT) compiler, the trace data concurrently with the execution of the set of executing business asset components;
determining, by the JIT compiler, that an executing business asset component is to invoke a different business asset component of the plurality of business asset components;
generating, by the JIT compiler based on the trace data, native binary executable code from source code that defines the different business asset component; and
causing, by the JIT compiler, the native binary executable code to be executed.

9. The method of claim 8, wherein receiving, by the computing system, the trace data generated by the set of executing business asset components further comprises receiving, by a just in time (JIT) compiler, the trace data concurrently with the execution of the set of executing business asset components;
determining, by the JIT compiler, that an executing business asset component is to invoke a different business asset component of the plurality of business asset components;
determining, by the JIT compiler, that the different business asset component comprises interpretable code;
determining, by the JIT compiler based on the trace data, to maintain the different business asset component as interpretable code; and
causing, by the JIT compiler, the different business asset component to be interpreted by an interpreter.

10. The method of claim 1 further comprising executing the business asset components via a business process model engine.

11. A computing system comprising:
one or more computing devices, the one or more computing devices comprising one or more processor devices, the one or more processor devices to:
receive trace data generated by a set of executing business asset components of a plurality of business asset components that form a business process application;
receive source code that defines the plurality of business asset components; and
generate, based on the trace data and the source code, native binary executable code for a first subset of the business asset components and maintaining interpretable code for a second subset of the business asset components.

12. The computing system of claim 11 wherein the one or more processor devices are further to:
determine, based on the trace data, that each business asset component in the first subset of business asset components executed a total number N times;
determine that the number N is greater than a determined threshold; and
in response to determining that the number N is greater than the determined threshold, generate the native binary executable code for each business asset component in the first subset of business asset components.

13. The computing system of claim 11 wherein the plurality of business asset components comprise one or more of a Business Process Model and Notation (BPMN) task business asset component, a Drool rule business asset component, and a Decision Model and Notation decision business asset component.

14. The computing system of claim 11, wherein the source code comprises one or more of a Decision Modeling and Notation (DMN) syntax, a Business Process Model Notation (BPMN) syntax, a Predictive Model Markup Language (PMML) syntax, and a Drools Rule Language (DRL) syntax.

15. The computing system of claim 11, wherein to receive, by the one or more processor devices, the trace data generated by the set of executing business asset components, the one or more processor devices are further to receive, by a just in time (JIT) compiler, the trace data concurrently with the execution of the set of executing business asset components;
determine, by the JIT compiler, that an executing business asset component is to invoke a different business asset component of the plurality of business asset components;
generate, by the JIT compiler based on the trace data, native binary executable code from source code that defines the different business asset component; and
cause, by the JIT compiler, the native binary executable code to be executed.

16. A non-transitory computer-readable storage medium that includes executable instructions to cause one or more processor devices of one or more computing devices to:
receive trace data generated by a set of executing business asset components of a plurality of business asset components that form a business process application;
receive source code that defines the plurality of business asset components; and
generate, based on the trace data and the source code, native binary executable code for a first subset of the business asset components and maintaining interpretable code for a second subset of the business asset components.

17. The non-transitory computer-readable storage medium of claim 16 wherein the instructions further cause the one or more processor devices further to:
determine, based on the trace data, that each business asset component in the first subset of business asset components executed a total number N times;
determine that the number N is greater than a determined threshold; and
in response to determining that the number N is greater than the determined threshold, generate the native binary executable code for each business asset component in the first subset of business asset components.

18. The non-transitory computer-readable storage medium of claim 16 wherein the plurality of business asset components comprise one or more of a Business Process Model and Notation (BPMN) task business asset component, a Drool rule business asset component, and a Decision Model and Notation decision business asset component.

19. The non-transitory computer-readable storage medium of claim 16, wherein the source code comprises one or more of a Decision Modeling and Notation (DMN) syntax, a Business Process Model Notation (BPMN) syntax, a Predictive Model Markup Language (PMML) syntax, and a Drools Rule Language (DRL) syntax.

20. The non-transitory computer-readable storage medium of claim 16, wherein to receive, by the one or more processor devices, the trace data generated by the set of executing business asset components, the instructions further cause the one or more processor devices to receive, by a just in time (JIT) compiler, the trace data concurrently with the execution of the set of executing business asset components;
determine, by the JIT compiler, that an executing business asset component is to invoke a different business asset component of the plurality of business asset components;
generate, by the JIT compiler based on the trace data, native binary executable code from source code that defines the different business asset component; and
cause, by the JIT compiler, the native binary executable code to be executed.
